(19) United States
(12) Patent Application Publication
(10) Pub. No.: US 2011/0170070 A1
(43) Pub. Date: Jul. 14, 2011

(54) LIGHT-MIXING MODULE AND OPTICAL PROJECTION SYSTEM

(76) Inventors: Hsin-Chang Wu, (US); Chang-An Tsai, (US); Yu-Min Liao, (US); Zhen-Xing Yan, (US)

(21) Appl. No.: 12/980,895

(22) Filed: Dec. 29, 2010

(30) Foreign Application Priority Data
Jan. 12, 2010 (CN) 2010100035163
Mar. 2, 2010 (TW) 099105899

(51) Int. Cl. G03B 21/28; G02B 27/14

(52) U.S. Cl. 353/31; 359/634

(57) ABSTRACT

A light-mixing module includes a first plate, a second plate, a first dichroic mirror, a second dichroic mirror, and a third dichroic mirror. The first dichroic mirror is disposed between the first plate and the second plate and is substantially perpendicular to the first plate and the second plate. The second dichroic mirror is disposed on a first side of the first dichroic mirror. The second dichroic mirror forms an angle with the first dichroic mirror and is substantially perpendicular to the first plate and the second plate. The third dichroic mirror is disposed on a second side of the first dichroic mirror and is substantially perpendicular to the first plate and the second plate. The third dichroic mirror is substantially parallel with the second dichroic mirror. The second dichroic mirror and the third dichroic mirror together form a fourth dichroic mirror, and at least one of the first dichroic mirror and the fourth dichroic mirror has a bevel gradient dichroic film.

### CROSS REFERENCE TO RELATED APPLICATION

This application claims priority of application No. 099105899 filed in Taiwan R.O.0 on Mar. 2, 2010 under 35 U.S.C. §119; the entire contents of which are hereby incorporated by reference.

### BACKGROUND OF THE INVENTION

a. Field of the Invention

The invention relates to a light-mixing module and an optical projection system including the light-mixing module.

b. Description of the Related Art

In a light-mixing module of a typical optical projection system, a dichroic mirror is used to reflect or transmit different light beams having mutually different colors to produce the effect of light combination. However, since a coating applied on a conventional dichroic mirror has an identical optical thickness at different regions of the dichroic mirror, the light beams reflected by or transmitted from the dichroic mirror show a non-uniform color distribution when the emitting light beams of a light source are not parallel light beams. For example, referring to FIG. 7, in case the emitting light beams of a light source are not parallel light beams, the non-parallel light beams are incident to a dichroic mirror 102 at different angles. As a result, reflection light beams R1, R2 and R3 from different regions of the dichroic mirror 102 have mutually different spectra, and transmission light beams T1, T2 and T3 from different regions of the dichroic mirror 102 also have mutually different spectra to cause the non-uniform color distribution. FIG. 8A shows a spectrum diagram where light beams are incident to a blue-reflecting dichroic mirror at different angles, and FIG. 8B shows a spectrum diagram where light beams are incident to a red-reflecting dichroic mirror at different angles. In these figures, curve X indicates a transmission spectrum at an angle of incidence of 55 degrees, curve Y indicates a transmission spectrum at an angle of incidence of 45 degrees, and curve Z indicates a transmission spectrum at an angle of incidence of 35 degrees. It is clearly seen from FIG. 8A and FIG. 8B, the transmission spectra at different angles of incidence for a conventional dichroic mirror with an identical coating thickness are not completely overlapped with each other. In other words, the reflection spectra or transmission spectra in different regions of a dichroic mirror are not identical to result in a non-uniform color distribution.

### BRIEF SUMMARY OF THE INVENTION

The invention provides a light-mixing module with fine color uniformity and an optical projection system having the light-mixing module.

Other advantages and objects of the invention may be further comprehended through the technical features disclosed in the invention.

In order to achieve one or part of or all the objectives or other objectives, a light-mixing module according to an embodiment of the invention includes a first plate, a second plate disposed opposite the first plate, a first dichroic mirror, a second dichroic mirror, and a third dichroic mirror. The first dichroic mirror is disposed between the first plate and the second plate and is substantially perpendicular to the first plate and the second plate. The second dichroic mirror is disposed on a first side of the first dichroic mirror. The second dichroic mirror forms an angle with the first dichroic mirror and is substantially perpendicular to the first plate and the second plate. The third dichroic mirror is disposed on a second side of the first dichroic mirror and is substantially perpendicular to the first plate and the second plate. The second side of the first dichroic mirror faces the back of the second dichroic mirror, and the third dichroic mirror is substantially parallel with the second dichroic mirror. The second dichroic mirror and the third dichroic mirror together form a fourth dichroic mirror, and at least one of the first dichroic mirror and the fourth dichroic mirror has a bevel gradient dichroic film.

In one embodiment, a first high-reflection coating is formed on an inner side of the first plate, the inner side of the first plate faces the first dichroic mirror, the second dichroic mirror and the third dichroic mirror, a second high-reflection coating is formed on an inner side of the second plate, and the inner side of the second plate faces the first dichroic mirror, the second dichroic mirror and the third dichroic mirror.

In one embodiment, the space between the first plate and the second plate is partitioned into a light-incident opening by the first dichroic mirror and the second dichroic mirror, and the space between the first plate and the second plate is partitioned into a light-emitting opening by the first dichroic mirror and the third dichroic mirror. The light-incident opening and the light-emitting opening are different in size.

According to another embodiment of the invention, an optical projection system includes a light source, a color separation device, a plurality of light valves, a light-mixing module, and a projection lens. The light source emits white light, and the color separation device is capable of separating the white light into different color light beams having mutually different colors. The light valves are capable of receiving the color light beams and modulating the color light beams according to an input image signal. The light-mixing module is capable of deflecting the color light beams to allow the color light beams to propagate in a substantially identical direction. The light-mixing module includes a first plate, a second plate disposed opposite the first plate, a first dichroic mirror, a second dichroic mirror, and a third dichroic mirror. The first dichroic mirror is disposed between the first plate and the second plate and is substantially perpendicular to the first plate and the second plate. The second dichroic mirror is disposed on a first side of the first dichroic mirror The second dichroic mirror forms an angle with the first dichroic mirror and is substantially perpendicular to the first plate and the second plate. The third dichroic mirror is disposed on a second side of the first dichroic mirror and is substantially perpendicular to the first plate and the second plate. The second side of the first dichroic mirror faces the back of the second dichroic mirror, and the third dichroic mirror is substantially parallel with the second dichroic mirror. The second dichroic mirror and the third dichroic mirror together form a fourth dichroic mirror, and at least one of the first dichroic mirror and the fourth dichroic mirror has a bevel gradient dichroic film. The projection lens is capable of receiving the color light beams from the light-mixing module to form an image.

In one embodiment, the color separation device includes a red-reflecting dichroic mirror, a green-reflecting dichroic mirror, and a blue-reflecting dichroic mirror. The light valves includes a liquid crystal panel for modulating red light, a liquid crystal panel for modulating green light, and a liquid crystal panel for modulating blue light.

The embodiments of the invention have at least one of the following advantages. According to the design of above embodiments, at least one of the first dichroic mirror and the fourth dichroic mirror has a bevel gradient dichroic film. The bevel gradient dichroic film has a gradually-varied optical thickness, and the optical thickness in different regions is varied according to different angles of incidence, so different light beams impinged on the first dichroic mirror at different angles of incidence achieve a substantially identical optical path length. Therefore, a substantially identical spectrum for different light beams having respective incidence angles is obtained to considerably reduce the non-uniform color distribution.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows an optical projection system according to an embodiment of the invention.

FIG.2A shows a three-dimensional diagram of a light-mixing module according to an embodiment of the invention, and FIG. 2B shows a plan view of FIG. 2A.

FIG. 3 shows a schematic diagram of a dichroic mirror according to an embodiment of the invention, where light beams are incident to the dichroic mirror at different angles.

FIGS. 4A-4C shows spectrum diagrams where light beams are incident to a blue-reflecting dichroic mirror with a bevel gradient dichroic film at different angles.

FIGS. 5A-5C shows spectrum diagrams where light beams are incident to a red-reflecting dichroic mirror with a bevel gradient dichroic film at different angles.

FIG. 6 shows a schematic diagram of a light-mixing module according to another embodiment of the invention.

FIG. 7 shows a schematic diagram of a conventional dichroic mirror, where light beams are incident to the dichroic mirror at different angles.

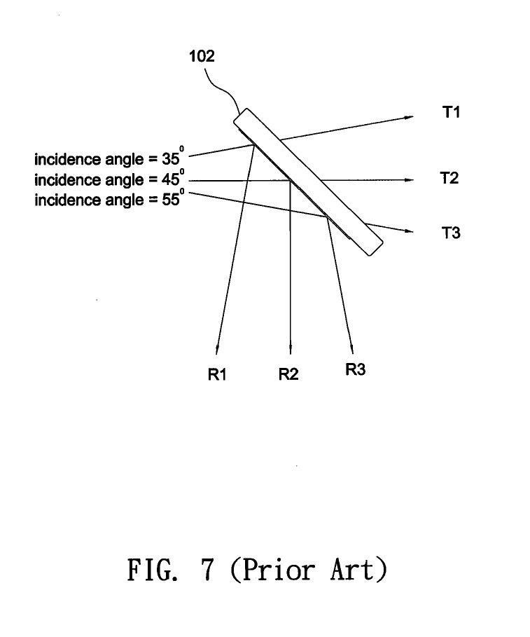

FIG. 8A shows a spectrum diagram where light beams are incident to a blue-reflecting dichroic mirror at different angles, and FIG. 8B shows a spectrum diagram where light beams are incident to a red-reflecting dichroic mirror at different angles.

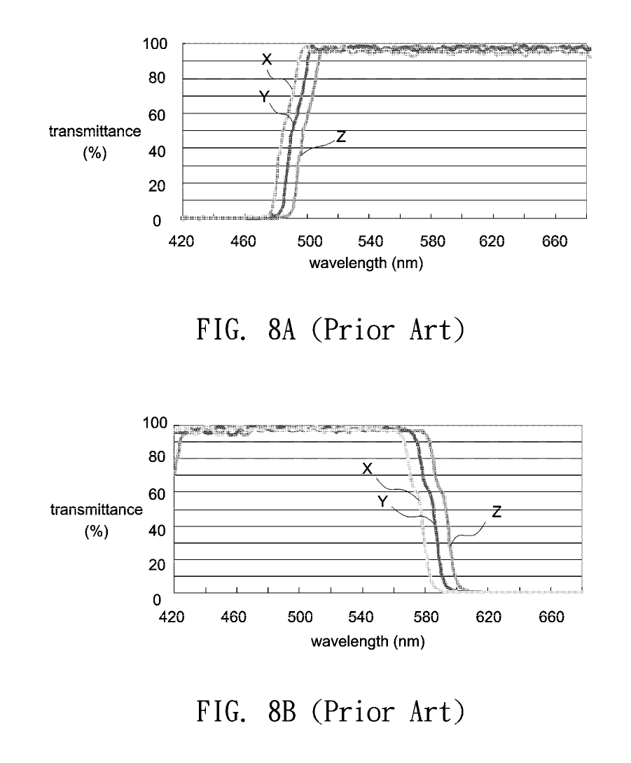

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc. , is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

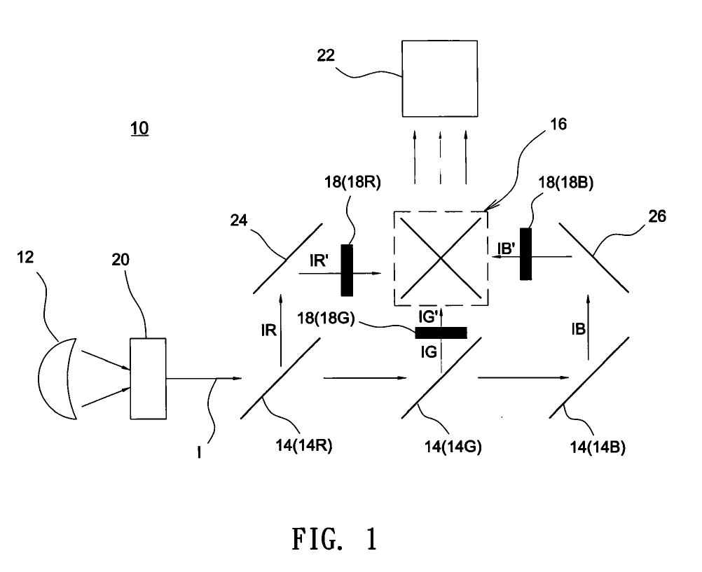

FIG. 1 shows an optical projection system according to an embodiment of the invention. Referring to FIG. 1, the optical projection system 10 includes a light source 12, a color separation device 14, a light-mixing module 16, a plurality of light valves 18, and a projection lens 22. The light source 12 is capable of emitting white light I, and the color separation device 14 is capable of separating the white light I passing through a light-homogenizing element 20 into different color beams having mutually different colors. In this embodiment, the color separation device 14 includes a red-reflecting dichroic mirror 14R, a green-reflecting dichroic mirror 14G, and a blue-reflecting dichroic mirror 14B, and the light valves 18 includes, for example, a liquid crystal panel 18R for modulating red light, a liquid crystal panel 18G for modulating green light, and a liquid crystal panel 18B for modulating blue light. The red-reflecting dichroic mirror 14R is capable of reflecting a red light beam IR and transmitting a green light beam IG and a blue light beam IB. The green-reflecting dichroic mirror 14G is capable of reflecting the green light beam IG and transmitting the blue light beam IB, and the blue-reflecting dichroic mirror 14B is capable of reflecting the blue light beam IB. The separated red light beam IR, green light beam IG, and blue light beam IB are respectively incident on the liquid crystal panel 18R for modulating red light, the liquid crystal panel 18G for modulating green light, and the liquid crystal panel 18B for modulating blue light. The liquid crystal panels 18R, 18G and 18B respectively modulate the red light beam IR, the green light beam IG and the blue light beam IB according to an input image signal. The modulated red light beam IR', green light beam IG' and blue light beam IB' are then combined by the light-mixing module 16. Reflective mirrors 24 and 26 are disposed between the color separation device 14 and the light-mixing module 16 to respectively reflect the red light beam IR and the blue light beam IB from the color separation device 14 and guide the red light beam IR and the blue light beam IB towards the light-mixing module 16. The projection lens 22 receives different color light beams IR, IG and IB propagating in an identical direction and then forms an image.

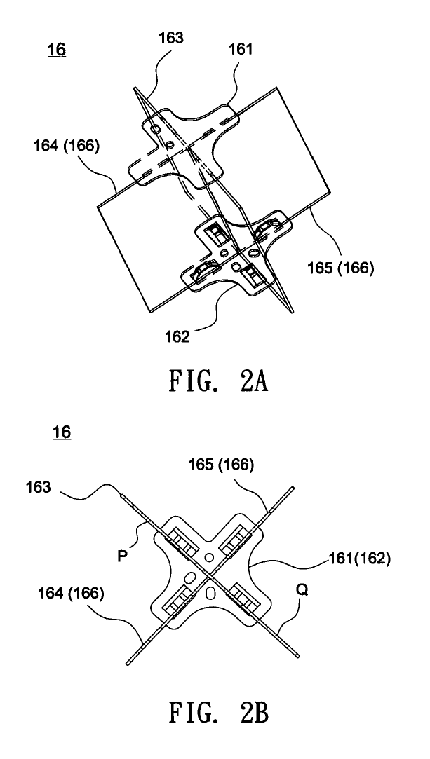

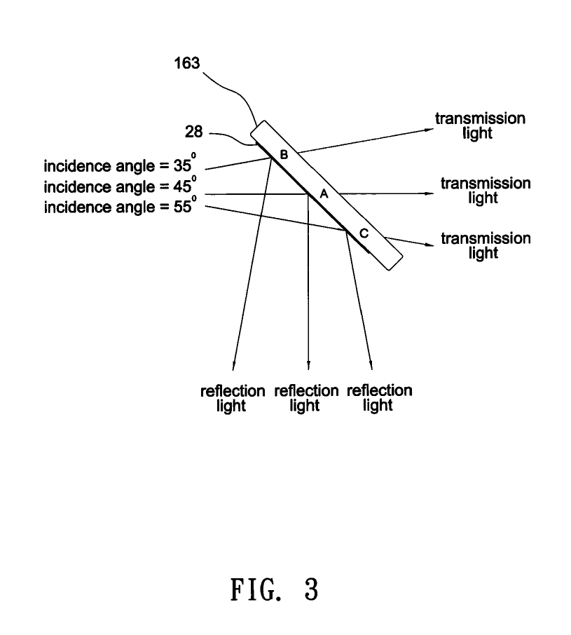

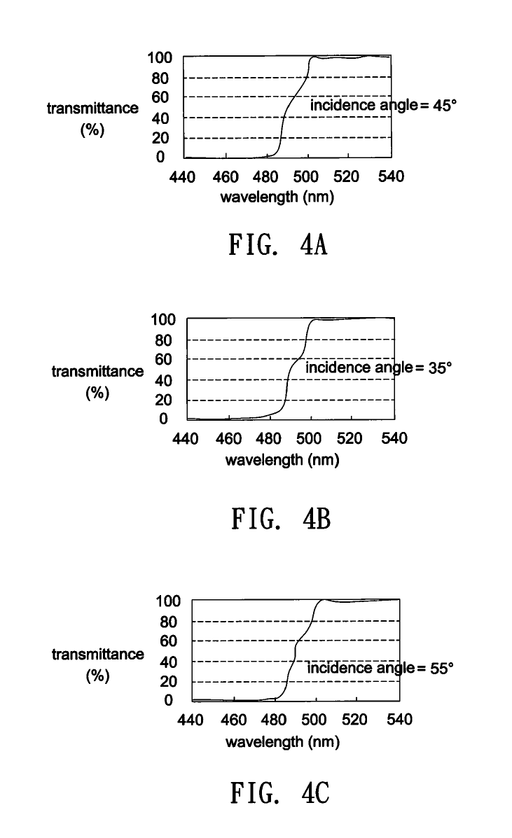

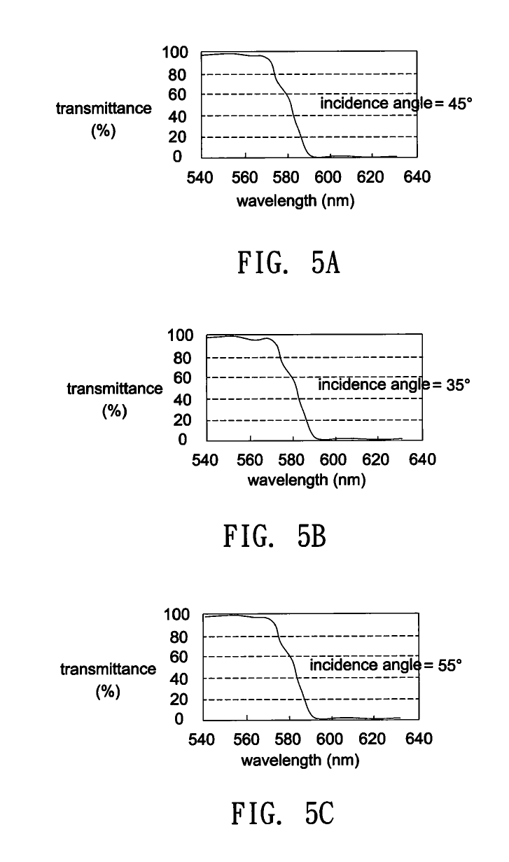

FIG. 2A shows a three-dimensional diagram of a light-mixing module according to an embodiment of the invention, and FIG. 2B shows a plan view of FIG. 2A. FIG. 3 shows a schematic diagram of a dichroic mirror according to an embodiment of the invention, where light beams are incident to the dichroic mirror at different angles. Please refer to FIG. 2A, FIG. 2B, and FIG. 3, in this embodiment, the light-mixing module 16 includes a first plate 161, a second plate 162, a first dichroic mirror 163, a second dichroic mirror 164, and a third dichroic mirror 165. The second dichroic mirror 164 and the third dichroic mirror 165 together form a fourth dichroic mirror 166. The first plate 161 is opposite the second plate 162 and is substantially parallel with the second plate 162. The first dichroic mirror 163 is disposed between the first plate 161 and the second plate 162, and the first dichroic mirror 163 is substantially perpendicular to the first plate 161 and the second plate 162. The second dichroic mirror 164 is disposed on a first side P of the first dichroic mirror 163 and forms an angle with the first dichroic mirror 163. The second dichroic mirror 164 is substantially perpendicular to the first plate 161 and the second plate 162. The third dichroic mirror 165 is disposed on a second side Q of the first dichroic mirror 163 and is substantially perpendicular to the first plate 161 and the second plate 162. The second side Q of the first dichroic mirror 163 faces the back of the second dichroic mirror 164, and the third dichroic mirror 165 is substantially parallel with the second dichroic mirror 164. In this embodiment, each of the first dichroic mirror 163, the second dichroic mirror 164, and the third dichroic mirror 165 has a bevel gradient dichroic film 28. In other words, each of the first dichroic mirror 163 and the fourth dichroic mirror 166 has a bevel gradient dichroic film 28. Referring to FIG. 3, the first dichroic mirror 163 is divided into three regions according to different angles of incidence; for example, a point A corresponds to an angle of incidence of 45 degrees, a point B corresponds to an angle of incidence of 35 degrees, and a point C corresponds to an angle of incidence of 55 degrees. The bevel gradient dichroic film 28 has a gradually-varied optical thickness, and the optical thickness in different regions is varied according to different angles of incidence, so different light beams impinged on the first dichroic mirror 163 at different angles of incidence achieve a substantially identical optical path length. Therefore, a substantially identical spectrum for different light beams having respective incidence angles is obtained to considerably reduce the non-uniform color distribution. FIGS. 4A-4C shows spectrum diagrams where light beams are incident to a blue-reflecting dichroic mirror with a bevel gradient dichroic film 28 at different angles. Referring to FIGS. 4A-4C, the transmission spectra at an angle of incidence of 45 degrees (FIG. 4A), 35 degrees (FIG. 4B) and 55 degrees (FIG. 4C) are substantially identical. Also, FIGS. 5A-5C shows spectrum diagrams where light beams are incident to a red-reflecting dichroic mirror with a bevel gradient dichroic film 28 at different angles. Referring to FIGS. 5A-5C, the transmission spectra at an angle of incidence of 45 degrees (FIG. 5A), 35 degrees (FIG. 5B) and 55 degrees (FIG. 5C) are substantially identical.

In one embodiment, the first dichroic mirror 163 is capable of reflecting the red light beam IR and transmitting the green light beam IG, and the second dichroic mirror 164 and the third dichroic mirror 165 are capable of reflecting the blue light beam IB and transmitting the green light beam IG. In an alternate embodiment, the first dichroic mirror 163 is capable of reflecting the blue light beam IB and transmitting the green light beam IG, and the second dichroic mirror 164 and the third dichroic mirror 165 are capable of reflecting the red light beam IR and transmitting the green light beam IG.

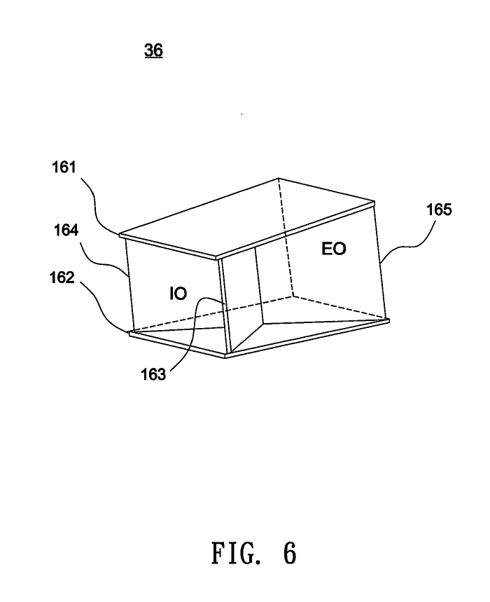

FIG. 6 shows a schematic diagram of a light-mixing module according to another embodiment of the invention. Referring to FIG. 6, in the light-mixing module 36, the space between the first plate 161 and the second plate 162 is partitioned into a light-incident opening 10 by the first dichroic mirror 163 and the second dichroic mirror 164, and the space between the first plate 161 and the second plate 162 is partitioned into a light-emitting opening EO by the first dichroic mirror 163 and the third dichroic mirror 165. In this embodiment, since the first plate 161 and the second plate 162 are not parallel with each other, the light-incident opening 10 and the light-emitting opening EO are different in size. In that case, a larger light-incident opening IO compared with a light-emitting opening EO results in a better light-focusing effect; in comparison, a larger light-emitting opening EO compared with a light-incident opening 10 may effectively converge a light-emitting angle.

In one embodiment, a high-reflection coating is formed on an inner side of the first plate 161, and the inner side of the first plate 161 faces the first dichroic mirror 163, the second dichroic mirror 164, and the third dichroic mirror 165. Also, a high-reflection coating is formed on an inner side of the second plate 162, and the inner side of the second plate 162 faces the first dichroic mirror 163, the second dichroic mirror 164, and the third dichroic mirror 165. In that case, the light reflection provided by the first plate 161 and the second plate 162 may reduce side-divergence of each light spot. In other words, the side of a light spot is flattened. Under the circumstance, the flattened light spot projected on a light-homogenizing element such as a fly-eye lens array is allowed to improve the light-utilization efficiency. Further, though, in the above embodiments, each of the first dichroic mirror 163, the second dichroic mirror 164, and the third dichroic mirror 165 (the first dichroic mirror 163 and the fourth dichroic mirror 166) has a bevel gradient dichroic film 28, this is not limited. In an alternate embodiment, at least one of the first dichroic mirror 163 and the fourth dichroic mirror 166 has a bevel gradient dichroic film 28. That is, only the first dichroic mirror 163 having a bevel gradient dichroic film 28, or only the second dichroic mirror 164 and the third dichroic mirror 165 having bevel gradient dichroic films 28 may also produce the effect of improving color uniformity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light-mixing module, comprising:
a first plate;
a second plate disposed opposite the first plate;
a first dichroic mirror disposed between the first plate and the second plate and being substantially perpendicular to the first plate and the second plate;
a second dichroic mirror disposed on a first side of the first dichroic mirror, the second dichroic mirror forming an angle with the first dichroic mirror and being substantially perpendicular to the first plate and the second plate; and
a third dichroic mirror disposed on a second side of the first dichroic mirror and substantially perpendicular to the first plate and the second plate, the second side of the first dichroic mirror facing the back of the second dichroic mirror, and the third dichroic mirror being substantially parallel with the second dichroic mirror;
wherein the second dichroic mirror and the third dichroic mirror together form a fourth dichroic mirror, and at least one of the first dichroic mirror and the fourth dichroic mirror has a bevel gradient dichroic film.

2. The light-mixing module as claimed in claim 1, wherein a first high-reflection coating is formed on an inner side of the first plate, the inner side of the first plate faces the first dichroic mirror, the second dichroic mirror and the third dichroic mirror, a second high-reflection coating is formed on an inner side of the second plate, and the inner side of the second plate faces the first dichroic mirror, the second dichroic mirror and the third dichroic mirror.

3. The light-mixing module as claimed in claim 1, wherein a space between the first plate and the second plate is partitioned into a light-incident opening by the first dichroic mirror and the second dichroic mirror, and the space between the first plate and the second plate is partitioned into a light-emitting opening by the first dichroic mirror and the third dichroic mirror.

4. The light-mixing module as claimed in claim 3, wherein the light-incident opening and the light-emitting opening are different in size.

5. The light-mixing module as claimed in claim 1, wherein the first plate is substantially parallel with the second plate.

6. The light-mixing module as claimed in claim 1, wherein the first dichroic mirror is capable of reflecting a red light beam and transmitting a green light beam, and the second dichroic mirror and the third dichroic mirror are capable of reflecting a blue light beam and transmitting the green light beam.

7. The light-mixing module as claimed in claim 1, wherein the first dichroic mirror is capable of reflecting a blue light beam and transmitting a green light beam, and the second dichroic mirror and the third dichroic mirror are capable of reflecting a red light beam and transmitting the green light beam.

8. An optical projection system, comprising:
a light source for emitting white light;
a color separation device capable of separating the white light into different color light beams having mutually different colors;
a plurality of light valves capable of receiving the color light beams and modulating the color light beams according to an input image signal;
a light-mixing module capable of deflecting the color light beams to allow the color light beams to propagate in a substantially identical direction, wherein the light-mixing module comprises:
a first plate;
a second plate disposed opposite the first plate;
a first dichroic mirror disposed between the first plate and the second plate and being substantially perpendicular to the first plate and the second plate;
a second dichroic mirror disposed on a first side of the first dichroic mirror, the second dichroic mirror forming an angle with the first dichroic mirror and being substantially perpendicular to the first plate and the second plate; and
a third dichroic mirror disposed on a second side of the first dichroic mirror and substantially perpendicular to the first plate and the second plate, the second side of the first dichroic mirror facing the back of the second dichroic mirror, and the third dichroic mirror being substantially parallel with the second dichroic mirror, wherein the second dichroic mirror and the third dichroic mirror together form a fourth dichroic mirror, and at least one of the first dichroic mirror and the fourth dichroic mirror has a bevel gradient dichroic film; and
a projection lens capable of receiving the color light beams from the light-mixing module to form an image.

9. The optical projection system as claimed in claim 8, wherein the color separation device comprises a red-reflecting dichroic mirror, a green-reflecting dichroic mirror, and a blue-reflecting dichroic mirror.

10. The optical projection system as claimed in claim 8, wherein the light valves comprise a liquid crystal panel for modulating red light, a liquid crystal panel for modulating green light, and a liquid crystal panel for modulating blue light.

11. The optical projection system as claimed in claim 8, further comprising at least one reflective mirror disposed between the color separation device and the light-mixing module to change propagation directions of the color light beams.

12. The optical projection system as claimed in claim 8, wherein a first high-reflection coating is formed on an inner side of the first plate, the inner side of the first plate faces the first dichroic mirror, the second dichroic mirror and the third dichroic mirror, a second high-reflection coating is formed on an inner side of the second plate, and the inner side of the second plate faces the first dichroic mirror, the second dichroic mirror and the third dichroic mirror.

13. The optical projection system as claimed in claim 8, wherein a space between the first plate and the second plate is partitioned into a light-incident opening by the first dichroic mirror and the second dichroic mirror, and the space between the first plate and the second plate is partitioned into a light-emitting opening by the first dichroic mirror and the third dichroic mirror.

14. The optical projection system as claimed in claim 13, wherein the light-incident opening and the light-emitting opening are different in size.

15. The optical projection system as claimed in claim 8, wherein the first plate is substantially parallel with the second plate.

16. The optical projection system as claimed in claim 8, wherein the first dichroic mirror is capable of reflecting a red light beam and transmitting a green light beam, and the second dichroic mirror and the third dichroic mirror are capable of reflecting a blue light beam and transmitting the green light beam.

17. The optical projection system as claimed in claim 8, wherein the first dichroic mirror is capable of reflecting a blue light beam and transmitting a green light beam, and the second dichroic mirror and the third dichroic mirror are capable of reflecting a red light beam and transmitting the green light beam.
